(19) United States
(12) Patent Application Publication
(10) Pub. No.: US 2010/0027984 A1
(43) Pub. Date: Feb. 4, 2010

(54) MIRROR DRIVE FOR A CAMERA

(76) Inventor: Hans-Jürgen Hartung, Wolfenbuttel (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/442,412

(22) PCT Filed: Sep. 21, 2007
(86) PCT No.: PCT/DE07/01732

§ 371 Date: Mar. 23, 2009

(30) Foreign Application Priority Data
Sep. 21, 2006 (DE) 10 2006 045 599.1

(51) Int. Cl. G03B 19/12

(52) U.S. Cl. 396/358

(57) ABSTRACT

Disclosed is a mirror drive for a camera, particularly a medium-size camera, in which both a mirror and an auxiliary shutter have to be swiveled. In order to use a small number of parts for producing said mirror drive and keep the design of the mirror drive uncomplicated, a motor is used which comprises a coil (11) and a magnet system (12) and in which the auxiliary shutter is directly coupled to the coil (11) and the mirror (40) is directly coupled to the magnet system (12). Preferably, the magnet system (12) and the coil (11) are mounted so as to be pivotable about the same pivot (14).

The invention relates to a mirror drive for a camera, in particular a medium-format camera.

Reflex cameras with mirrors are known to be designed such that the beam path from the objective falls directly on the surface to be exposed, in the form of a film which can be exposed, a digital sensor or the like. The exposure time is controlled in the normal manner by a shutter. After taking the photograph, the beam path to the light-sensitive sensor or film is blocked by an auxiliary shutter flap and a mirror is then folded in, by means of which the motif being looked at through the objective is deflected in order to carry out a viewfinder function in such a way that, in the case of a cubic housing, the viewfinder can be arranged on the upper face or on the side wall of the housing.

In the rest position, the auxiliary shutter flap is folded out in order to prevent light from passing through to the light-sensitive recording part. In addition, the mirror is folded into the beam path in order to allow the viewfinder function to be used to find the direction of the desired object through the objective.

When it is intended to take a photograph, a shutter release is operated. Apart from the shutter control, a defined procedure takes place for the parts that are of interest here, specifically the auxiliary shutter flap and the mirror. First of all, the mirror is folded up. Once this has been done, the auxiliary shutter flap is likewise folded away such that—apart from the exposure shutter—the beam path from the objective to the light-sensitive recording part is free. After the exposure for the photography, the auxiliary shutter flap is first of all folded into the beam path again and the mirror is then pivoted back to its initial position in order to allow the viewfinder function again.

Using a known technique, such as that which has been implemented in the Rollei 6008 medium-format camera, the pivoting movement of the mirror on the one hand and of the auxiliary shutter flap on the other hand is controlled by springs which can be loaded and are unlocked at the time at which the shutter release is operated, such that the movement of the auxiliary shutter flap and the coil is controlled by the associated springs as the load is taken off them. Since the movement must be carried out quickly, springs with a considerable spring force must be used, in which case the spring for the heavy mirror must have a higher spring force than the spring for the lighter auxiliary shutter flap. In order to comply with the further requirement, specifically ensuring that the mirror and the auxiliary shutter flap move as smoothly as possible, dampers are used which reduce the speed created by the spring as the load is removed from it, before the movement is ended. A servo drive is required to load the springs again, by means of which the locking and the release can also be controlled. The known apparatus is thus constructed from a large number of parts which must be matched to one another in a complicated manner.

The present invention is based on the object of making it possible to create the movement processes for the pivoting of the auxiliary shutter flap and of the mirror when taking a photograph, using a simplified arrangement with few individual parts, thus reducing the complexity of the mirror drive.

According to the invention, in order to achieve this object, the mirror drive is designed with a motor with a coil and magnet system, in which the auxiliary shutter flap is coupled directly to the coil and the mirror is coupled directly to the magnet system.

A motor which is formed from a coil and magnet system is known. The current flow through the coil results in a magnetic field which interacts with the magnetic field of the magnet system and—depending on the flow direction of the current flowing through the coil—produces a force at right angles to the field direction and current flow direction in both directions. In the case of the mirror drive according to the invention, the magnet system is directly coupled to the mirror and the auxiliary shutter flap is directly coupled to the coil in order to form a direct drive. The current flow through the coil leads to a relative movement of the coil in the magnet system. The auxiliary shutter flap can thus be moved when the magnet system is fixed. Since the magnet system is directly coupled to the mirror in order to provide a direct drive, the magnet system is moved relative to the coil in another phase, with the coil being fixed, in order to allow the movement for the direct drive of the mirror.

In one preferred embodiment of the invention, the magnet system and the coil are mounted such that they can pivot about the same rotation point. In consequence, both the magnet system and the coil carry out a pivoting movement about this rotation point.

The magnet system and the coil are provided with control arms for coupling to the mirror and to the auxiliary shutter flap respectively, one of which control arms is coupled to the mirror and the other to the auxiliary shutter flap.

In order to control all the movements of the auxiliary shutter flap and of the mirror, the current flow direction through the coil is in each case reversed and the coil or the magnet system is fixed in order to produce the respectively required relative movement.

The fixing of the magnet system or of the coil, and/or of the associated control arm which is connected to the magnet system or to the coil, is preferably carried out by means of a moving control element whose movement is caused by the movement of the control arms by means of driver elements and control sections. The control element can in this case preferably rotate backward and forward through a limited rotation angle.

The control arms can preferably be in the form of two-armed levers whose rotation point coincides with the rotation point of the mounting of the magnet system and/or of the coil and, beyond the rotation point, has a slotted guide for an associated pin, which engages in the slot, with the pin being fitted to an operating arm which is connected to the mirror and to the auxiliary shutter flap respectively in order to form the direct drive.

The arrangement according to the invention makes it possible to control a movement process for taking a photograph in a preferred manner in two phases and, after taking a photograph, in a further two phases, that is to say in a total of four phases. In this case, the mirror and the auxiliary shutter flap are pivoted into the direct beam path in an initial position, in order to allow a viewfinder function. In order to take a photograph, the current is first of all passed through the coil in a first current direction and the coil is fixed with the auxiliary shutter flap, as a result of which the magnet system is pivoted relative to the coil, and folds the mirror out of the beam path.

The current flow direction through the coil is then reversed, and the magnet system is fixed together with the mirror in the assumed position such that the auxiliary shutter flap is thus pivoted out of the beam path. The exposure time can now be controlled by operation of the main camera shutter, by which means the photograph is taken by the light-sensitive part.

Once an image has been taken, the coil is pivoted with the auxiliary shutter flap first of all by once again reversing the polarity of the current flow direction with the first current flow direction and while still keeping the magnet system fixed with the mirror, and the magnet system with the mirror is then pivoted to the initial position by once again reversing the polarity of the current flow direction and fixing the coil with the auxiliary shutter flap.

The magnet system is preferably controlled, in order to pivot the mirror in one direction, in the opposite direction, with the mass of the magnet system corresponding approximately to the mass of the mirror. Pulse compensation and weight compensation are carried out in this way since the movements of the parts which comprise the mirror system and magnet system, which have approximately the same mass, cancel one another out.

The coil is analogously controlled, in order to pivot the auxiliary shutter flap in one direction, in the opposite direction, with the mass of the coil corresponding approximately to the mass of the auxiliary shutter flap. The mass of the auxiliary shutter flap is considerably less than the mass of the mirror.

In one preferred embodiment of the invention, the movement of the control arms can be checked by means of light barriers and studs which are arranged one behind the other in the movement direction, and can be influenced as a function of position by controlling the current through the coil. This makes it possible, for example, for there to be no sudden braking of the magnet system at the end of the movement, but gradual braking at the end of the movement, as a result of which the movement can be carried out considerably more smoothly. The dynamic response of the mirror step can be influenced by controlling the current through the coil.

An arrangement of studs which allows identification of the two limit positions is also advantageous.

It is advantageous for the control arm which is connected to the magnet system to be connected to an operating arm, which is mounted such that it can rotate, for the mirror via a slot-pin guide such that the pin carries out a backward and forward movement in the slot during the movement from one limit position of the magnet system to the other, and such that the pin is additionally connected to the control arm via a spring which presses the mirror into two defined positions, which correspond to the limit positions of the magnet system. The spring is compressed by the forward movement until a maximum compression state is exceeded. As the load is removed from the spring, the spring then assists the movement of the magnet system to the other limit position. A bistable spring arrangement such as this means that the mirror is always controlled to its defined limit positions and, as can be seen, this is of major importance for the operation of the camera.

The control arm which is connected to the coil is also preferably provided in an analogous manner with a corresponding operating arm of the auxiliary shutter flap, with a corresponding bistable spring being provided which ensures that the auxiliary shutter flap assumes its completely open limit position or its completely closed limit position.

The invention will be explained in more detail in the following text with reference to exemplary embodiments which are illustrated in the drawing, in which:

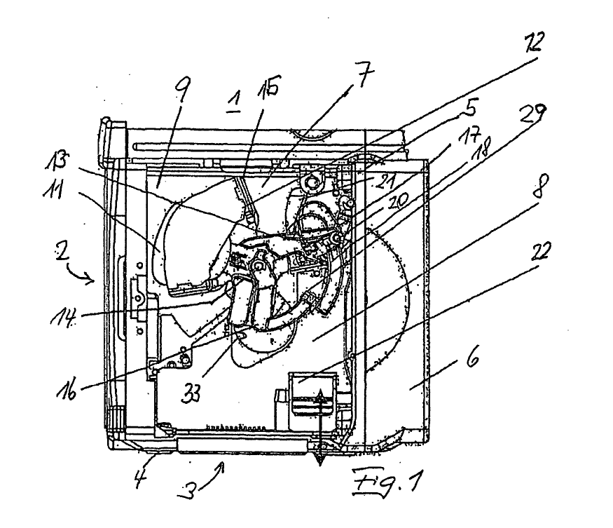

FIG. 1 shows a plan view of the mirror drive according to the invention, which is located in a side wall of the camera housing;

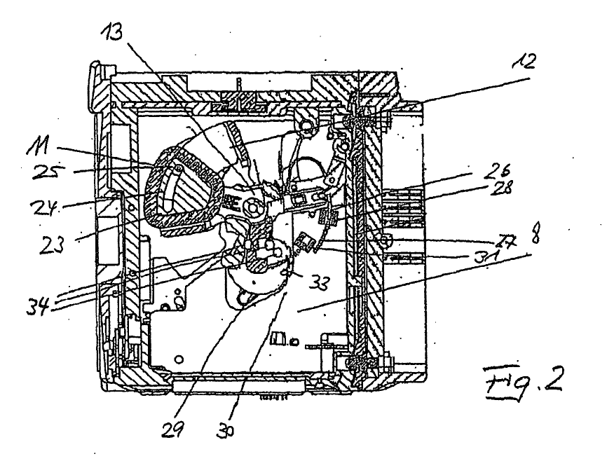

FIG. 2 shows a section, with a section plane parallel to the side wall, through the mirror drive;

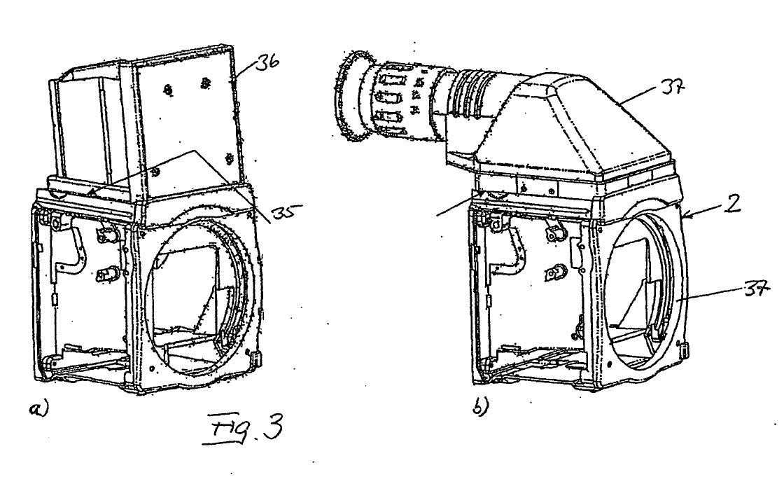

FIG. 3 shows a perspective illustration of the (partially open) camera housing with a box-type viewfinder fitted, and alternatively with a prismatic viewfinder fitted;

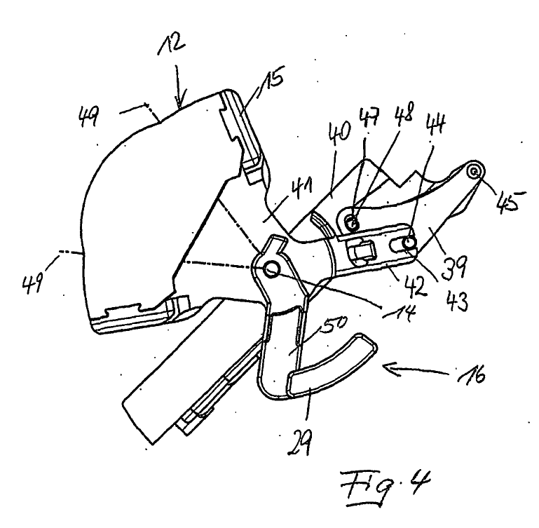

FIG. 4 shows a view of the magnet system with the control arms sprayed on, illustrated here engaged with a pin of an operating arm, which is connected to the mirror such that they rotate together;

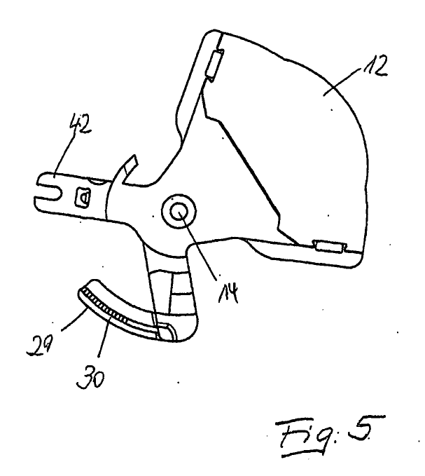

FIG. 5 shows a view of the magnet system with the control arms (without driven mirror) from underneath;

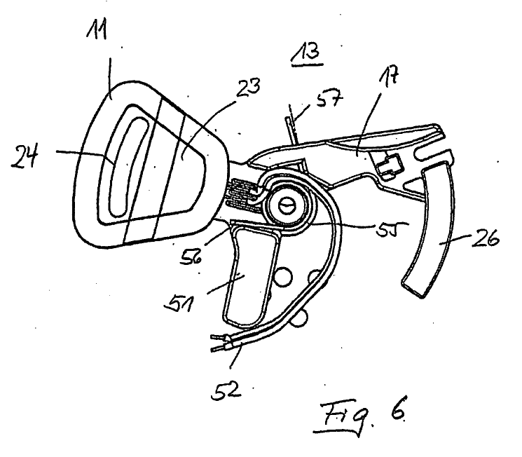

FIG. 6 shows a view of the wound flat coil with sprayed-on operating arms and with connecting lines fitted, from above;

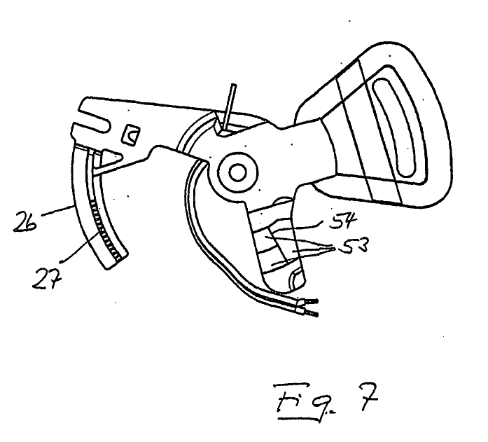

FIG. 7 shows a view of the arrangement illustrated in FIG. 6 from underneath;

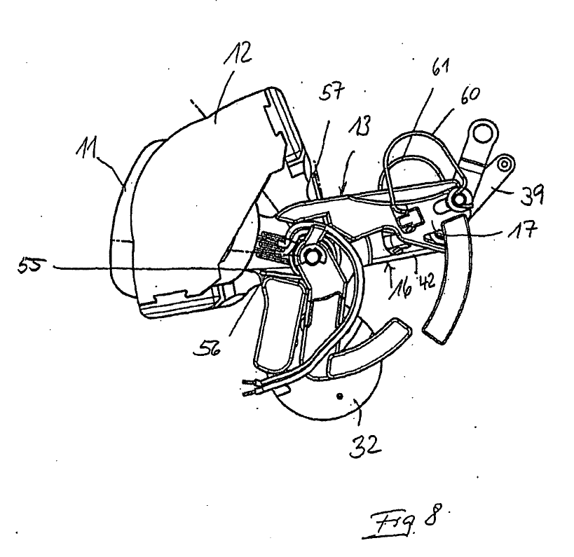

FIG. 8 shows an assembly comprising the drive, which is formed from the magnet system and the coil with the respective control arms and acts on operating arms of the mirror and of the auxiliary shutter flap, in an initial position in which the mirror and the auxiliary shutter flap are pivoted into the direct beam path;

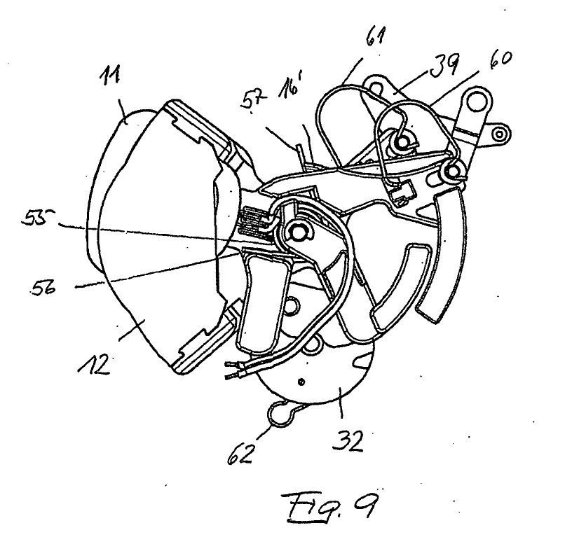

FIG. 9 shows a first step in the taking of a photograph, in which the magnet system is pivoted with the coil fixed, in order to pivot the mirror out of the beam path;

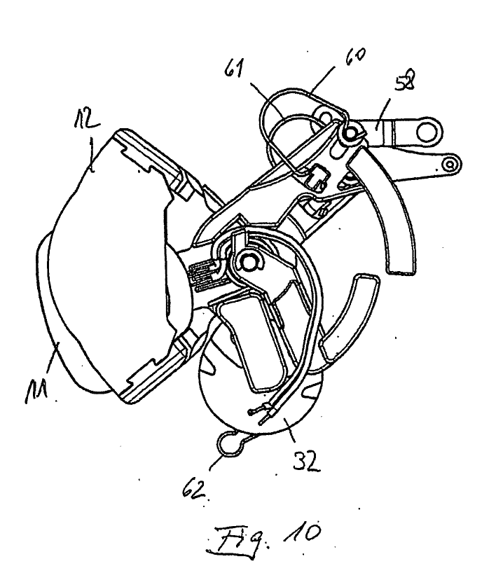

FIG. 10 shows a state after carrying out the next movement step, in which the coil is pivoted in the fixed magnet system in order to pivot the auxiliary shutter flap out of the beam path;

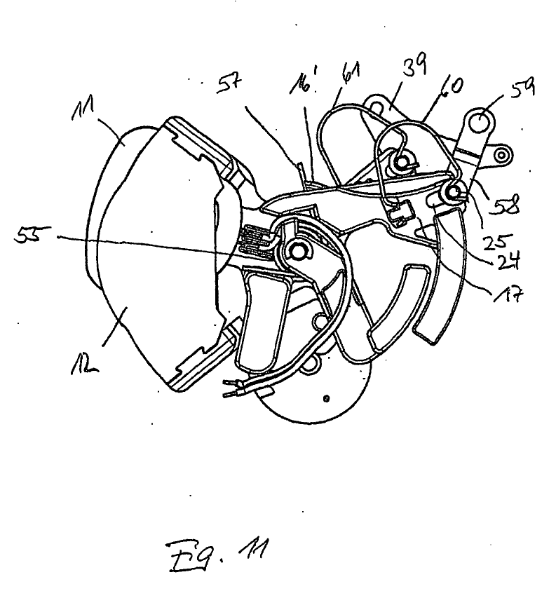

FIG. 11 shows a state after a first movement step after taking a photograph, by means of which the auxiliary shutter flap has been pivoted back into the beam path again. The initial state in FIG. 8 is reached again by subsequently pivoting the magnet system.

FIG. 1 shows a camera housing 1 of a medium-format camera with a front face 2 which is used to hold objectives (not illustrated). A lower face 3 has feet 4 for placing the camera down on a base.

The housing, which is open per se on its rear face 5 opposite the front face 2, can be closed in a known manner by a functional rear wall 6 that can be fitted. The functional rear wall may, for example, be formed by a film magazine or by a digital sensor.

The housing is completed by side walls (not illustrated), of which one side wall has been removed for the illustration in FIG. 1, in order to make it possible to see a drive according to the invention.

FIG. 1 shows a mounting plate 7 and a printed circuit board 8, held thereon, behind the removed side wall. The drive arrangement is separated from the interior of the camera by a wall 9.

The illustrated drive has a motor 10 in the form of a flat coil 11 which is wound in a trapezoidal shape and can be moved between two positions in a magnet system 12. For this purpose, the coil is provided with a coil former 23 (FIG. 6), which is integrally connected to a control arm arrangement 13. The control arm arrangement is mounted at a rotation point 14 in such a way that the coil 11 can pivot about the rotation point 14.

In a known manner, the magnet system 12 has two pairs of opposite magnets of different polarity, as a result of which a drive force is formed for each of the two coil sections that are located in the air gap, at right angles to the field direction and to the current flow direction. If the current flow direction through the coil 11 is reversed, the coil 11 is moved in the opposite direction relative to the magnet system 12, by which means the two limit positions of the coil 11 are reached. The magnet system 12 is fixed by closure pieces 15 in the area of the limit positions.

The magnet system 12 also has a control arm arrangement 16, which is likewise mounted such that it can rotate about the rotation point 14. The control arm arrangement 16 is formed integrally with the closure pieces 15.

The control arm arrangement 13 of the coil 11 has a control arm 17 which, seen from the coil 11, has an elongated slot 18 at the free end beyond the rotation point 14, in which elongated slot 18 a pin 20, which is mounted on an operating lever 19 which can pivot, is held such that it can move. The operating lever 19 which can pivot is connected to an auxiliary shutter flap (not illustrated) of the camera such that they rotate together, by means of which the open rear face 5 can be closed such that light cannot pass through. In a similar manner, the control arm arrangement 16 of the magnet system 12 is connected to an operating arm of the mirror of the camera, which is mounted such that it can pivot and is articulated on the mirror through a slot section 21, in the form of an arc, in the mounting plate 7 and the wall 9.

FIG. 1 also shows an unlocking button 22 on the lower edge of the side wall, by means of which a lock for the fitted functional wall 6 can be released in such a way that, for example, it is possible to replace a film magazine through a digital rear wall without any problems and quickly.

The section illustration in FIG. 2 has been chosen such that the section plane runs through the winding of the coil 11, such that a coil former 23 on which the coil is mounted can be seen in the form of a section. The coil former 23 is provided with a slot 24 which is in the form of a circular arc section and in which a pin 25, which is firmly connected to the magnet system 12, is guided. The pin-elongated slot arrangement 24, 25 thus limits the relative movement between the coil 11 and the magnet system 12, with the ends of the elongated slot 24 defining the limit positions.

As can be seen from FIG. 2, the control arm arrangement 13 of the coil 11 has an attachment 26 which is in the form of an arc and is fitted with studs 27 which are arranged one behind the other in the longitudinal direction. These studs 27 pass through a light barrier 28, depending on the pivoting movement of the coil 11, in such a way that the arrangement comprising the light barrier 28 and the studs 27 makes it possible to determine the instantaneous position of the coil 11 from one limit position to the other.

The control arm arrangement 16 of the magnet system 12 analogously has an attachment 29 which is in the form of an arc and is fitted with correspondingly arranged studs 30 which are used together with a light barrier 31 to determine the position of the magnet system 12, which is mounted such that it can pivot.

FIGS. 1 and 2 also show a cam disk 32 which is mounted about a central rotation axis, which is at right angles to the disk plane, and is rotated in one direction or the other through a specific rotation angle as a result of the movement of the control arm arrangements 13, 16, with the cam disk 32 being formed with studs 33 and spring pins 34 mounted in it such that the desired movement procedure, as will be described in more detail in the following text, is complied with and, for example, undesirable movement back to a previous phase in the procedure is blocked.

FIG. 3 shows the camera housing obliquely from the front face. The upper face 35 of the camera housing is provided with a matt viewfinder panel, in such a way that a box-type viewfinder 36 or a prismatic viewfinder 37 can be fitted onto the upper face and allows the viewfinder function behind the camera in the direction in which a photograph is being taken. An objective with a bayonet fitting can be inserted into the opening 38, which can be seen in the front face 2.

FIGS. 4 and 5 show a detailed illustration of the magnet system 12 with the associated control arm arrangement 16, as well as an operating arm 39 which is coupled thereto and provides the pivoting movement of the mirror 40 of the mirror reflex camera.

The control arm arrangement 16 extends from the magnet system 12, which is in the form of an arc section, with a tapering section 41 to the rotation point 14. The integrally formed control arm arrangement 16 extends beyond the rotation point 14 with a control arm 42 away from the magnet system 12. An elongated slot 43 is located at the free end of the control arm and is open toward the free end. A pin 44 of the operating lever 39 is guided in the elongated slot 43. The operating lever 39 is mounted such that it can rotate on a rotation shaft 45 on which the mirror 40 is also mounted such that it can pivot. The operating lever 39 has an arm section 46 which is located alongside and below the control arm 42 and has an aperture hole 47 through which a screw 48 projects, which is connected to the mirror 40 and allows adjustment of the angle between the operating lever 39 and the mirror 40.

The axis 49 which is illustrated by a dashed line in FIG. 4 shows that the magnet system 12 can pivot through a specific angle about the rotation point 14. The pivoting movement results in the operating lever 39—and therefore the mirror 40—being pivoted via the control arm 42 such that the pivoting movement of the mirror 40 is driven directly by the magnet system 12.

Seen from the magnet system 12, the control arm arrangement 16 also has the attachment 29, which is in the form of an arc, beyond the rotation point 14 at the end of a connecting arm 50 whose radius of curvature corresponds to the distance between the attachment 29 and the rotation point 14.

As can be seen from the illustration of the lower face in FIG. 5, the studs 30, by means of which the instantaneous position of the magnet system 12 can be detected in conjunction with the light barrier 31, are arranged on the lower face of the attachment 29.

FIGS. 6 and 7 show the single part which comprises the coil former 23 on which the coil 11 is wound, the control arm 17 with the attachment 26 which is in the form of an arc, and a further control arm 51 which interacts with the cam disk 32. The illustration also shows two lines 52 via which the coil 11 can be supplied with current in the two different current flow directions. The view of the lower face in FIG. 7 illustrates the position of the studs 27 on the attachment 26 which is in the form of an arc. The illustration also shows inclines 53 with locking edges 54 which interact with the spring pins 34 on the cam disk in order to provide the locking for the control arm arrangement 16 or 13 and the rotary movement of the cam disk 32 in conjunction with the studs 33.

A spring clip 55 with two end arms 56, 57 is also mounted on the control arm arrangement 13, in the area of the rotation point 12. While the one end arm 56 is used to support the helical spring, the other end arm 57 projects out of the contour of the control arm arrangement 13 and acts as a driver for the control arm arrangement 16 of the magnet system 12.

FIGS. 8 to 11 show four phases of the control of the mirror and of the auxiliary shutter flap during the release process in order to take a picture.

FIG. 8 shows the arrangement comprising the magnet system 12 with the associated control arrangement 16, the coil 11 with the associated control arm arrangement 13 and the cam disk 32 which controls the movement procedure, in a first phase which corresponds to the rest position of the camera. This rest position allows a viewfinder function, because the mirror 40 has been pivoted into the beam path of the camera (from the front face 2 to the rear face 5). Furthermore, the auxiliary shutter flap has also been pivoted downward in order in this way to block the beam path from the front face 2 to the rear face 5 of the camera.

In FIG. 8, the magnet system 12 is located in a position in which it has been pivoted upward. The operating arm 39 for the mirror has been pivoted downward via the control arm 42.

The coil 11 is located in a lower limit position relative to the magnet system 12, although this limit position corresponds to the upper limit position of the coil 11 with respect to the possible pivoting angle of the coil 11.

When a current in a suitable current flow direction now flows through the coil 11 and the coil 11 is at the same time prevented from moving by the cam disk 32, the magnet system 12 is now moved downward on its pivoting path, as is illustrated in FIG. 9, while the position of the coil 11 remains unchanged. In consequence, the mirror 40 is pivoted upward by the operating arm 39, which is now pivoted upward, that is to say it is moved out of the direct beam path of the camera.

The control arm arrangement 16, which is connected to the magnet system 12, has an attachment 16′ which runs into the end arm 57 of the spring clip 55 at the end of this movement, and deflects this end arm 57, as is indicated by a dashed line in FIG. 8. On the one hand, this brakes the movement of the magnet system shortly before it reaches its limit position, and on the other hand it provides an initial acceleration to assist the subsequent movement of the coil 11 which is produced by reversing the polarity of the current through the coil 11 at a synchronized time.

In this case, the cam disk 32 has been moved such that it now prevents movement of the magnet system 12. As a result of reversing the polarity of the current flow direction through the coil 11, this coil 11 now moves downward in the magnet system 12, as a result of which an operating arm 58 which is coupled to it is pivoted upward, as is illustrated in FIG. 10. The operating arm is coupled directly to that of the auxiliary shutter flap, in such a way that the latter is now likewise pivoted out of the beam path. In consequence, the camera is now ready to take a photograph. The exposure is controlled in the normal manner by the camera shutter.

After carrying out the exposure, the coil 11 is moved upward in the magnet system 12, which is still fixed, as is illustrated in FIG. 11. In consequence, the operating arm 58 pivots downward about its rotation axis 59, as a result of which the auxiliary shutter flap once again blocks the beam path in the camera. The magnet system 12 is being moved upward by reversing the polarity of the current flow direction in the coil 11 and fixing the coil 11, as a result of which the mirror 40 is folded into the beam path and the initial position shown in FIG. 8 is reached, in which a viewfinder function is possible. While the coil 11 is being pivoted up to the function illustrated in FIG. 11, the end arm 57 of the spring clip 55 runs into the attachment 16′ and is articulated somewhat. This somewhat brakes the movement of the coil 11 shortly before reaching its limit position, and at the same time provides the magnet system 12 with an initial acceleration for the subsequent movement to the initial state.

As can be seen from FIGS. 8 to 11, a U-shaped spring 60 is clamped in between the control arm 17 and the pin 25 of the operating arm 59 and pushes the pin 25 away from the control arm 17. Since the operating arm 58 moves on a circular path, which intersects the circular path of the operating arm, and since the limit positions of the operating arm 58 as illustrated in FIG. 11 and FIG. 10 are dependent on a maximum distance of the pin 25 in the elongated slot 24, the spring 60 assists the process of the limit positions of the operating arm 58, and therefore of the auxiliary shutter flap, being assumed correctly.

A corresponding spring 61 acts in the same way for the corresponding bistable control of the operating arm 39 for the mirror 40, in such a way that the spring 61 ensures that the mirror 40 is always correctly positioned in its limit positions.

A similar spring 62, which projects below the cam disk 32 in FIGS. 9 and 11, has a comparable function, and in each case pushes the cam disk 32, which acts as a rocker, to one of its two limit positions.

As can be seen, the entire drive for both the mirror 40 and for the auxiliary shutter flap as well as the cam disk 32 is provided exclusively by current being passed through the coil 11 in different current flow directions. The number of parts required for the drive is extremely small since the only parts which are the control arm arrangement 13 which is connected to the coil 11 as one part, the control arm arrangement 16 which is connected to the magnet system 12 and is a further individual part, and the cam disk 32 are required. The movement is transmitted with the aid of the operating arms 39 and 58 which only guide the movement, which is directly driven by the drive, of the mirror 40 and of the auxiliary shutter flap, respectively.

1. A mirror drive for a camera having a motor with a coil (11) and a magnet system (12), in which an auxiliary shutter flap is coupled directly to the coil (11) and the mirror (40) is coupled directly to the magnet system (12).

2. The mirror drive as claimed in claim 1, characterized in that the magnet system (12) and the coil (11) are mounted such that they can pivot about the same rotation point (14).

3. The mirror drive as claimed in claim 1, characterized in that the magnet system (12) and the coil (11) are each provided with a control arm arrangement (13, 16), one of which is coupled to the mirror (40) and the other is coupled to the auxiliary shutter flap.

4. The mirror drive as claimed in claim l, characterized in that all the movements of the auxiliary shutter flap and of the mirror (40) can be controlled by reversing the polarity of the current flow direction through the coil (11) and by suitable fixing of the coil (11) or of the magnet system (12).

5. The mirror drive as claimed in claim 4, characterized in that the magnet system (12) or the coil (11) is fixed by a moving control element (32), whose movement is caused by the movement of the control arm arrangements (13, 16) by means of driver elements and control sections.

6. The mirror drive as claimed in claim 1, characterized in that control arm arrangements (13, 16) have control arms (17, 42) which are in the form of two-armed levers which, beyond the rotation point (12), have a slot guide for an associated pin (25, 44) which engages in the slot (25, 43), and in that the pin (25, 44) is fitted to an operating arm (39, 58) which is connected to the mirror (40) and to the auxiliary shutter flap in order to form the direct drive.

7. The mirror drive as claimed in claim 1, characterized in that, in an initial position, the mirror (40) and the auxiliary shutter flap are pivoted into the direct beam path, in that, in order to take a photograph, the coil (11) first of all has current passed through it in a first current flow direction and the coil is fixed with the auxiliary shutter flap, such that the magnet system (12) is pivoted relative to the coil (11) and folds the mirror (40) out of the beam path, and in that the current direction through the coil (11) is then reversed and the magnet system (12) is fixed together with the mirror (40) in the assumed position such that the auxiliary shutter flap is in this way pivoted out of the beam path.

8. The mirror drive as claimed in claim 7, characterized in that, after an image has been taken, the coil (11) is pivoted with the auxiliary shutter flap first of all by once again reversing the polarity of the current flow direction to the first current flow direction, and by fixing the magnet system (12) with the mirror (40), and the magnet system (12) with the mirror (40) is then pivoted to the initial position by once again reversing the polarity of the current flow direction and fixing the coil (11) with the auxiliary shutter flap.

9. The mirror drive as claimed in claim 1, characterized in that the magnet system (12) is controlled for pivoting the mirror (40) in one direction is moved to the opposite direction, and in that the mass of the magnet system (12) corresponds approximately to the mass of the mirror (40).

10. The mirror drive as claimed in claim 1, characterized in that the coil (11) is controlled, for pivoting the auxiliary shutter flap in one direction, to the opposite direction, and in that the mass of the coil (11) corresponds approximately to the mass of the auxiliary shutter flap.

11. The mirror drive as claimed in claim 1, characterized in that the movement of the control arm arrangements (13, 16) can be checked by means of light barriers (28, 31) and studs (27, 30) which are arranged one behind the other in the movement direction, and can be influenced as a function of position by controlling the current through the coil (11).

12. The mirror drive as claimed in claim 1, characterized in that the control arm (42), which is connected to the magnet system (12), is connected to an operating arm (39), which is mounted such that it can rotate, for the mirror via a slot-pin guide such that the pin (44) moves backward and forward in the slot (43), and such that the pin (44) is additionally connected to the control arm (42) via a spring (61) which presses the mirror (40) into two defined positions, which correspond to the limit positions of the magnet system (12).

13. The mirror drive as claimed in claim 1, characterized in that the control arm (17) which is connected to the coil (11) is connected to an operating arm (58), which is mounted such that it can rotate, for the auxiliary shutter flap via a slot-pin guide such that the pin (25) carries out a backward and forward movement in the slot (24) during the movement from one limit position of the coil (11) to the other, and such that the pin (25) is additionally connected to the control arm (17) via a spring (60) which presses the auxiliary shutter flap into two defined positions, which correspond to the limit positions of the coil (11).

14. The mirror drive as claimed in claim 1, characterized in that the control arm arrangements (13, 16) come into contact with one another via an elastic element (57) when the coil (11) is moved in one direction relative to the magnet system (12), and the magnet system (12) is then moved in the same direction and away from the coil (11).

15. The mirror drive as claimed in claim 1, characterized in that the control arm arrangements (13, 16) come into contact with one another by an elastic element (57) when the magnet system (12) is moved in one direction relative to the coil (11) and the coil (11) is then moved in the same direction and away from the magnet system (12).

16. The mirror drive as claimed in claim 14, characterized in that the elastic element is an end arm (57) of a spring clip (55), which is mounted on one of the control arm arrangements (13, 16), and in that the end arm (57) comes to rest on an attachment (16′) of the other of the control arm arrangements (13, 16).
